(19) United States
(12) Patent Application Publication
(10) Pub. No.: US 2003/0138221 A1
(43) Pub. Date: Jul. 24, 2003

(54) Optical fiber module

(75) Inventors: Junichi Hasegawa, Tokyo (JP); Tsunetoshi Saito, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: The Furukawa Electric Co., Ltd., Tokyo (JP)

(21) Appl. No.: 10/285,513

(22) Filed: Nov. 1, 2002

Related U.S. Application Data
(63) Continuation of application No. PCT/JP02/04431, filed on May 7, 2002.

(30) Foreign Application Priority Data
May 8, 2001 (JP) 2001-136874

(51) Int. Cl. G02B 6/42

(52) U.S. Cl. 385/92

(57) ABSTRACT

An optical fiber module includes an optical component housed inside a package. One end of an optical fiber is connected to the optical component. Another end of the optical fiber is drawn to outside of the package. The optical fiber is fixed to the optical fiber fixing part of the package between the one end and the another end of the optical fiber when temperature in the optical fiber fixing part is kept at a temperature lower than an upper limit temperature of the usable temperature range of the optical component by at least approximately 0° C. and at most approximately 30° C.

### CROSS-REFERENCES TO RELATED APPLICATIONS

The present application claims priority under 35 U.S.C. §119 to Japanese Patent Application No. 2001-136874, filed May 8, 2001. Further, the present application claims priority under 35 U.S.C. §120 to International Application No. PCT/JP02/04431, filed May 7, 2002. The contents of those applications are incorporated herein by reference in their entirety.

### BACKGROUND OF THE INVENTION

1. Field of the Invention

The present invention relates to an optical fiber module.

2. Discussion of the Background

In recent years, the research and development of the wavelength division multiplexing optical communication have been conducted actively as a technique for dramatically increasing transmission capacity in optical communications. With research and development, the commercialization of highly sophisticated optical components has been proceeding.

Generally, the optical components are comprised of relatively fragile materials such as glass, and thus the influence of external forces needs to be avoided in using the optical components. On this account, the optical components, connecting parts of an optical fiber to the optical component or the like are packaged.

The optical components, the parts connecting the optical fiber to the optical component or the like are packaged in this manner, whereby an optical fiber module is formed. By the packaging of the optical fiber module, the optical components, the parts connecting the optical fiber to the optical component and the like are protected, and the mechanical strength thereof is increased.

A traditional optical fiber module has a form in which the optical component is fixed to a package, or the optical fiber connected to the optical component is fixed to a package with an adhesive at room temperature. For example, the room temperature is 20° C. This traditional optical fiber module has had the following problem because it comprises an optical component or optical fiber packaged at room temperature.

More specifically, when ambient temperature rises, the package, the optical component, and the optical fiber expand. However, the length of linear expansion in the package, for example, is greatly different from the length of linear expansion in the optical component and optical fiber. Accordingly, a force is applied to the part connecting the optical component to the optical fiber to increase optical insertion loss, or to damage the optical component or deteriorate optical characteristics.

As an example, an optical fiber module 1 shown in FIG. 3B will be described. This optical fiber module 1 is formed to have an optical component 7 housed inside a package 5. As shown in FIG. 3A, the optical component 7 is formed to have optical fiber arrays 3 on one end side of a Planar Lightwave Circuit (PLC) 2 and on the other end side. To each end side of the optical component 7, one end of an optical fiber 4 lined up with one of the optical fiber arrays 3 is connected. Additionally, the optical fiber 4 in FIG. 3A on the right side is an optical fiber 4 in which a plurality of optical fibers is collected and formed into tape-like configuration.

As shown in FIG. 3B, the other end side of both the optical fibers 4 is passed through holes 5a disposed in two faces of the package 5 facing each other, and drawn outside the package 5. A middle portion of both the optical fibers 4 is attached and fixed to optical fiber fixing parts 5b in the external walls of the package 5 with an adhesive 6.

More specifically, in the optical fiber module shown in FIG. 3B, the optical fiber fixing parts 5b are disposed in plural (here, it is two). One of the optical fiber fixing parts 5b is disposed in a wall part 5c1 of the external wall of the package 5, and the other optical fiber fixing part 5b is disposed in a wall part 5c2 of the external wall of the package 5 facing opposite the aforesaid wall part 5c1.

In this optical fiber module 1, when ambient temperature is changed, the package 5, the optical component 7, and the optical fibers 4 expand and contract. When the amount of package length expansion or contraction that is generated at time when ambient temperature is changed from a preset temperature where the optical fibers 4 are fixed to the optical fiber fixing parts 5b is set to dlₚ, this amount of change is expressed by the following equation (1):

dlₚ=β_{P}·l_{P}·dθ (1)

Where l_{P} is a package length at the preset temperature, dθ is an amount of temperature changed based on the preset temperature, and β_{P} is a linear expansion coefficient of the package 5. Additionally, when the change in length of the optical fibers 4 and the optical component 7 (amount of stretch) that is generated at time when ambient temperature is changed from a preset temperature is set to dl_{c}, this amount of change is expressed by the following equation (2):

dl_{c}=β_{C}·l_{C}·dθ (2)

Where l_{C} is a value combining the length

of the optical component 7 and the length of the optical fibers 4 in the area housed inside the package 5 at the preset temperature, dθ is the amount of temperature change from the preset temperature, and β_{C} is a linear expansion coefficient combining the optical component 7 and the optical fibers 4.

For example, when the linear expansion coefficient of the Planar Lightwave Circuit (PLC) 2 of the optical component 7 is β₁, the length is L₁, the linear expansion coefficient of the optical fiber arrays 3 is β₂, the length is L₂, the linear expansion coefficient of the optical fibers 4 is β₃, and the length is L₃, the amount of change is determined by equation (3).

dlc=(β₁·L₁+β₂·L₂+β₃·L₃)·dθ (3)

Here, the preset temperature is the temperature at which the optical fibers 4 are fixed; for example, it is 20° C. in the case of a traditional example.

In this example, a material of the package 5 is set to aluminum, the linear expansion coefficient β_{P} is 2.31×10⁻⁵/° C. The linear expansion coefficient β_{C} combining the optical component 7 and the optical fibers 4 is 2.5×10⁻⁶/° C.

Here will be considered an example where both the length l_{P} of the package 5 and the length l_{C} combining the length of the optical component 7 and that of the optical fibers 4 in the area housed inside the package 5, are 100 mm at the preset temperature of 20° C.

In this case, as apparent from equation (1), when temperature rises by 70° C. (the amount of temperature change is 70° C.), the package length l_{P} is stretched about 160 μm. Additionally, as apparent from equation (2), when the amount of temperature change is 70° C., the length l_{P} combining the length of the optical component 7 and the optical fibers 4 in the area housed inside the package 5 is stretched about 18 μm.

Accordingly, in this case, the optical fibers 4 are drawn into the package 5 due to the difference of length stretched between l_{P} and l_{C}. Thus, a force is applied to the connection part of the optical fibers 4 to the Planar Lightwave Circuit (PLC) 2, thereby the optical insertion loss increases.

As described above, increase of the optical insertion loss, damage of the optical component or deterioration of optical characteristics is generated in the traditional optical fiber module 1, due to the difference between the length of the linear expansion in the package 5 and the length of the linear expansion in the optical component 7 or in the optical fibers 4 housed inside the package 5.

Here, a method for avoiding such the damage of the optical component or deterioration of optical characteristics is proposed. This method is that a package is fixed to optical fibers at temperatures higher than the highest temperature for use of an optical fiber module, whereby tension is not applied to the optical fibers at temperatures of use. This method is disclosed in Japanese Patent Laid-Open No. 152308/1992. The contents of this application are incorporated herein by reference in their entirety.

However, when the package is fixed to the optical fibers at temperatures higher than the highest temperature for use as described above, the following problem has arisen.

For example, the case where the usable temperature range in the optical component 7 is set at temperatures from 0 to 70° C. and the package 5 is fixed to the optical fibers 4 at temperatures higher than 70° C. will be described in the example described above. In this case, the optical fibers 4 becomes loose about 140 μm at a temperature of 0° C.

When vibrations or impact are applied to the optical fiber module in such the state of the optical fibers having greater looseness, deterioration of optical characteristics or damage might be generated.

In addition, when the optical fibers become loosened, transmission loss due to microbend might be generated even though vibrations or impact are not applied to the optical fibers.

Furthermore, when the work to fix the package to the optical fibers is conducted at high temperatures, a material such as an adhesive configuring the optical fiber module might be adversely affected.

### SUMMARY OF THE INVENTION

According to one aspect of the present invention, an optical fiber module includes a package having at least one optical fiber fixing part, an optical component housed inside the package, and at least one optical fiber having one end and another end. The one end is connected to the optical component. The another end is drawn to outside of the package through a hole disposed in the package. The at least one optical fiber is fixed to the at least one optical fiber fixing part between the one end and the another end of the at least one optical fiber when temperature in the at least one optical fiber fixing part is kept at a temperature lower than an upper limit temperature of the usable temperature range of the optical component by at least approximately 0° C. and at most approximately 30° C.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 depicts an explanatory view illustrating the fabrication process in one embodiment of the optical fiber module in the invention;

FIG. 2 depicts a view illustrating relationship between ambient temperature and optical insertion loss;

FIG. 3A depicts a perspective view illustrating one example of the optical component;

FIG. 3B depicts a cross-section illustrating the optical fiber module having the optical component shown in FIG. 3A packaged;

FIG. 4 depicts one example of a relationship between ambient temperature and optical insertion loss in the optical fiber module;

FIG. 5 depicts a perspective view illustrating another example of the optical fiber module;

FIG. 6 depicts a cross-section of still another example of the optical fiber module; and

FIG. 7 depicts a cross-section of yet another example of the optical fiber module.

### DESCRIPTION OF THE EMBODIMENTS

The embodiments will now be described with reference to the accompanying drawings, wherein like reference numerals designate corresponding or identical elements throughout the various drawings.

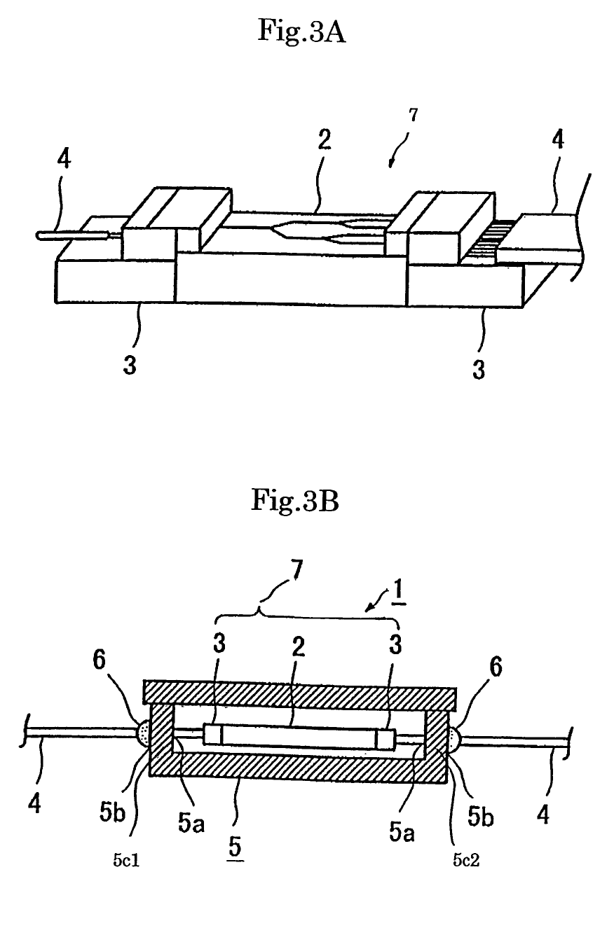

The invention is based on the new knowledge obtained as a result of dedicated experimental investigation. The example of the optical fiber module shown in FIG. 3B has the linear expansion coefficient β_{P} of the package greater than the linear expansion coefficient β_{C} of the combination of the optical component and the optical fiber. That is, β_{P}>β_{C}.

When this optical fiber module has the configuration of the traditional example, the optical fibers 4 are attached and fixed to the optical fiber fixing parts 5b with the temperature in the optical fiber fixing parts 5b of the package 5 set to a temperature of 20° C.

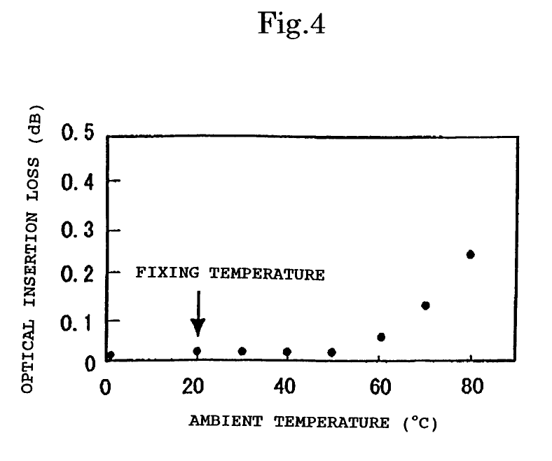

The optical fiber module 1 having such fixing procedure of the optical fibers 4 is varied as shown in FIG. 4 according to ambient temperature. More specifically, the optical insertion loss between the optical fibers 4 and the Planar Lightwave Circuit (PLC) 2 hardly increases at all when ambient temperature is changed from a temperature of 20° C. to about 50° C. However, when ambient temperature rises higher than a temperature of 60° C., the optical insertion loss between the optical fibers 4 and the Planar Lightwave Circuit (PLC) 2 is increased greatly, and thus the optical insertion loss is increased as temperatures become high.

This phenomenon is considered to occur because the optical insertion loss is proportional to the square of the misalignment between the two optical axes. That is, it is because the misalignment between the optical axes of the optical fibers and the optical components is small when slight force is applied to the optical fibers, and thus the optical insertion loss does not change so much, whereas when a great force is applied to the optical fibers, the misalignment of the optical axes becomes greater and leads to an increase in the optical insertion loss.

Additionally, when a force applied to the optical fibers is a slight force, it is considered that elastic deformation in the optical fibers and the adhesive relaxes this force applied to the connecting parts of the optical component to the optical fibers.

From this, when β_{P}>β_{C}, the inventor set the temperature T of the optical fiber fixing parts when fixing the optical fibers to the optical fiber fixing parts firmly with no looseness at a temperature lower than the upper limit temperature T₁ in the usable temperature range of the optical component by at least approximately 0° C. and at most approximately 30° C.

Also in this case, tension is applied to the optical fibers fixed to the optical fiber fixing parts by changes between the temperature T₁ and temperature T. However, in this case, the temperature range from the temperature T at which the optical fibers 4 are fixed to the upper limit temperature T₁ at which the optical component can be used is approximately 30° C. or under. Thus, as apparent from FIG. 4, the optical insertion loss is hardly increased at all.

Additionally, at temperatures between the temperature T and the lower limit temperature T₂ in the usable temperature range in the optical component, looseness is generated in the optical fibers fixed to the optical fiber fixing parts. However, the extent of looseness is smaller than the optical fiber module fixed at the temperature T in the optical fiber fixing parts at higher temperatures than the upper limit temperature T₁. Accordingly, the optical fiber module of the invention makes deterioration of the optical characteristics or damage due to vibrations or impact smaller as compared with the optical fiber module fixed in the optical fiber fixing parts at a temperature T higher than the upper limit temperature T₁.

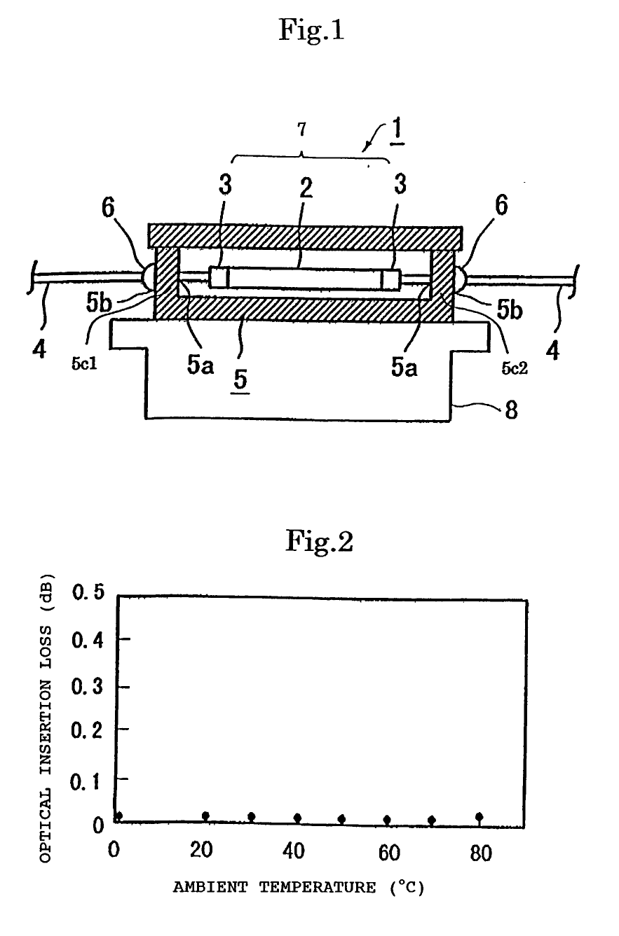

As shown in FIG. 1, the optical fiber module according to an embodiment of the present invention is formed in which an optical component 7 is housed inside a package 5 and optical fibers 4 connected to the optical component 7 are fixed to the package 5. Additionally, FIG. 1 depicts an explanatory view illustrating fabrication process of the optical fiber module of one embodiment.

The fabrication process of the embodiment is as follows. More specifically, a first process of the optical fiber module fabrication is a process for housing the optical component 7 in the package 5 comprised of aluminum 100 mm in length. The optical component 7 is formed by connecting an optical fiber array 3 on both sides of a Planar Lightwave Circuit (PLC) 2. The optical fibers 4 lined up at both the optical fiber arrays 3 are inserted into through holes 5a disposed in two faces of the package 5 facing each other.

A second process of the optical fiber module fabrication is a process for placing the package 5 on a heating unit 8 such as a hot plate and the like, after which the heating unit 8 is operated to give heat, as shown in FIG. 1. The temperature of the heating unit 8 is set at a temperature lower than the upper limit temperature of use of the Planar Lightwave Circuit (PLC) 2 by at least approximately 0° C. and at most approximately 30° C. In this case, the usable temperature range of the Planar Lightwave Circuit (PLC) 2 is a temperature from approximately 0° C. to approximately 70° C. The preset temperature of the heating unit 8 was set to a temperature of 50° C., 20° C. lower than 70° C. which is the upper limit temperature in the aforesaid usable temperature range.

A third process of the optical fiber module fabrication is a process for fixing the optical fibers 4 to optical fiber fixing parts 5b disposed in the external walls of the package 5. Fixing the optical fibers is conducted after the heating unit 8 is heated to the aforementioned preset temperature (it is 50° C., here) and the package 5 also is heated to a temperature of 50° C. More specifically, the optical fibers 4 are attached and fixed to the optical fiber fixing parts 5b with an adhesive 6 in a state that the optical fiber fixing parts 5b of the package 5 are set to a temperature of 50° C. The adhesive 6 is not limited particularly, but here the product with trade name “POS seal” (Cemedine Co., Ltd.) was used.

The package 5, the Planar Lightwave Circuit (PLC) 2, the optical fiber arrays 3, and the optical fibers 4 of the optical fiber module 1 all fabricated as described above expand in length at the upper limit temperature of use, 70° C., as compared with their length at time of fixing the optical fibers 4. The length of the package 5 expands 45 μm. The length of the combination of the Planar Lightwave Circuit (PLC) 2, the optical fiber arrays 3 and the optical fibers 4 expands by about 5 μm.

Accordingly, the difference between these extensions is about 40 μm. The optical fibers 4 are drawn out to some degree, but the force thereby applied to the optical fibers 4 is smaller than with the case where they are attached and fixed at room temperature (20° C.).

In addition, at temperatures equal to or lower than 50° C. (attaching and fixing temperature), the contraction of the package 5 is greater than the contractions of the optical fiber arrays 3 and the optical fibers 4, and the optical fibers 4 are loosened. However, the amount of looseness is smaller than the case where the optical fibers 4 are attached and fixed at temperatures higher than the upper limit temperature in the usable temperature range. The risks of deterioration of optical characteristics or damage in the optical fiber module due to vibrations or impact become smaller.

When the optical insertion loss of the optical fiber module 1 of the embodiment is measured, it is almost zero in the usable temperature range (0 to 70° C.) as depicted in FIG. 2, showing excellent temperature characteristic.

More specifically, the optical fiber module 1 of the embodiment hardly has any optical insertion loss in the usable temperature range and can prevent deterioration of optical characteristics or damage due to vibrations or impact.

Furthermore, the invention is not limited to the embodiment. For example, in the optical fiber module 1 of the embodiment, the optical component 7 was formed of the Planar Lightwave Circuit (PLC) 2 and the optical fiber arrays 3, but the optical component 7 may not have the Planar Lightwave Circuit (PLC) 2 or optical fiber arrays 3. That is, the configuration of the optical component 7 set as is appropriate.

Moreover, in the invention, the method for fixing the optical fibers to the package is not limited to the method of the adhesive as the embodiment. More specifically, the temperature in the optical fiber fixing parts 5b of the package 5 is set to temperatures 0 to 30° C. lower than the upper limit temperature in the usable temperature range of the optical component 7 and then the optical fibers 4 are fixed to the optical fiber fixing part 5b is acceptable.

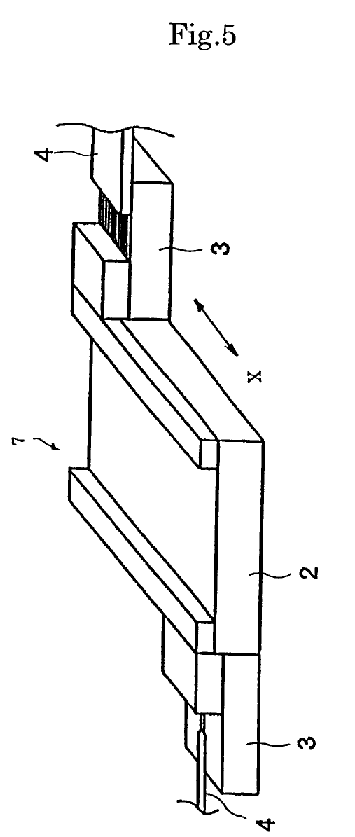

Besides, in the optical fiber module of the embodiment, the optical fibers 4 were disposed to both end sides of the Planar Lightwave Circuit (PLC) 2 which is the optical component 7 and the two groups of optical fibers 4 were arranged in a straight line opposite to each other. However, as shown in FIG. 5, the positions at which the optical fibers 4 are fixed to the Planar Lightwave Circuit (PLC) 2 in the optical fiber module may be shifted in the X-direction in FIG. 5.

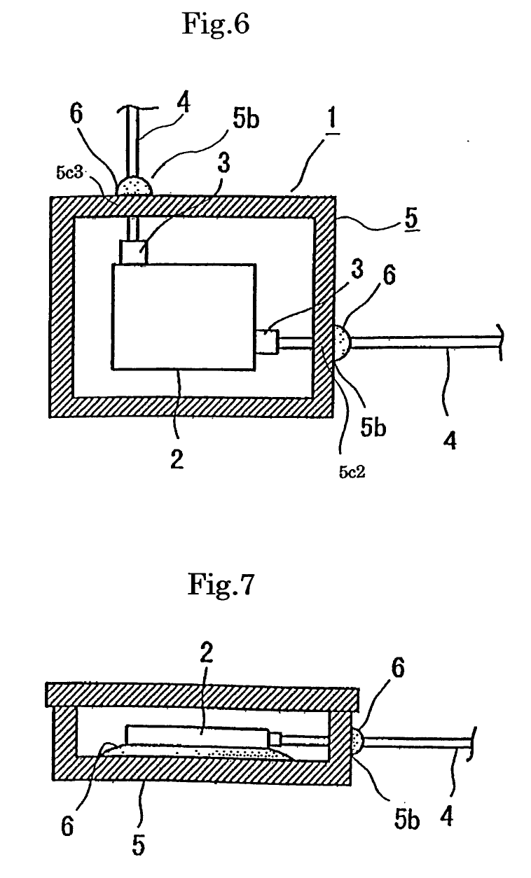

Additionally, in the embodiment described above, each of the optical fiber fixing parts 5b was disposed in the external walls of the wall parts 5c1 and 5c2 of the package 5 which face each other. However, as shown in FIG. 6, for example, the optical fiber fixing parts 5b may be disposed in wall parts not facing each other; for example the optical fiber fixing parts 5b may be disposed in wall parts 5c2 and 5c3.

Furthermore, in the embodiment as described above, the optical fiber fixing parts 5b were disposed in the external walls of the package 5. However, the positions of the optical fiber fixing parts 5b are not limited particularly; they may be set as is appropriate. For example, the optical fiber fixing parts 5b may be disposed in the through holes 5a.

Moreover, as shown in FIG. 7, the invention is also applied to the case where the optical fiber 4 is connected only to one end side of the Planar Lightwave Circuit (PLC) 2, if the optical components are attached and fixed to the package 5.

Besides, the optical component does not need to be fixed to the package 5 directly. It may be fixed through a component such as a Peltier device and the like.

In addition, the number of optical fibers 4 connected to one end side or the other end side of the optical component is set to any arbitrary number from one upward, corresponding to the numbers of optical input parts and optical output parts of the optical component and so on, for example.

As described above, the optical fiber module according to embodiments of the invention can reduce the optical insertion loss of the optical fibers in the usable temperature range and can prevent deterioration of optical characteristics or damage due to vibrations or impact. Therefore, it is suitable as an optical fiber module for use in the wavelength division multiplexing optical communication, and the like.

Obviously, numerous modifications and variations of the present invention are possible in light of the above teachings. It is therefore to be understood that within the scope of the appended claims, the invention may be practiced otherwise than as specifically described herein.

What is claimed as new and is desired to be secured by Letters Patent of the United States is:

1. An optical fiber module comprising:
a package having at least one optical fiber fixing part;
an optical component housed inside the package; and
at least one optical fiber having one end and another end, the one end being connected to said optical component, the another end being drawn to outside of said package through a hole disposed in said package, said at least one optical fiber being fixed to the at least one optical fiber fixing part between the one end and the another end of the at least one optical fiber when temperature in said at least one optical fiber fixing part is kept at a temperature lower than an upper limit temperature of the usable temperature range of said optical component by at least approximately 0° C. and at most approximately 30° C.

2. The optical fiber module according to claim 1, wherein said package has first and second optical fiber fixing parts and first and second wall parts facing each other, said first optical fiber fixing part is disposed in the first wall part, and said second optical fiber fixing part is disposed in the second wall part.

3. The optical fiber module according to claim 1, wherein the optical component is fixed to the package.

4. The optical fiber module according to claim 2, wherein the optical component is fixed to the package.
